(19) United States
(12) Patent Application Publication
(10) Pub. No.: US 2003/0228456 A1
(43) Pub. Date: Dec. 11, 2003

(54) Leather covering piece for a vehicle interior lining, a vehicle interior lining and a method for the production of a leather covering piece and of a vehicle interior lining

(75) Inventor: Achim Hehl, Hosbach (DE)

Correspondence Address: Tarolli, Sundheim, Covell & Tummino L.L.P., Suite 1111, 526 Superior Avenue, Cleveland, OH, 44114-1400, US

(73) Assignee: TRW Automotive Safety Systems GmbH & Co. KG

(21) Appl. No.: 10/460,568

(22) Filed: Jun. 12, 2003

Related U.S. Application Data
(62) Division of application No. 09/798,551, filed on Mar. 2, 2001, now abandoned.

(30) Foreign Application Priority Data
Mar. 6, 2000 (DE) 100 10 862.8

(51) Int. Cl. B32B 3/26; B32B 5/24; B32B 3/00; D21H 11/00; D21H 13/00

(52) U.S. Cl. 428/304.4; 428/315.9; 428/311.11

(57) ABSTRACT

A leather covering piece for a vehicle interior lining comprises a leather piece and an intermediate layer connected with the leather piece. A hardenable mass is applied onto the intermediate layer or the leather piece. The hardened mass gives the leather covering piece such an inherent rigidity that it maintains a curved shape and can be inserted into an injection mold. The stacking of prefabricated leather covering pieces is also possible. The shape of the leather covering piece already corresponds to that of the finished product, in particular of the vehicle interior lining for which it is used. The leather covering piece is back-molded in order to obtain a stable carrier piece which gives the entire interior lining more stability.

### TECHNICAL FIELD

The invention relates to a leather covering piece for an interior lining of a motor vehicle and also a method for the production of such a leather covering piece. In addition, the invention relates to an interior lining with a leather covering piece according to the invention and a method for the production of such an interior lining.

### BACKGROUND OF THE INVENTION

Vehicle interior linings provided with a leather surface are very popular owing to the high quality visual appearance and the pleasant feel to the touch. Leather-covered steering wheels are particularly in demand, but also leather-coated gas bag covers, instrument panels and door linings are known. In a known method, firstly a plastic piece is produced, having the corresponding shape, which then has leather coverings glued on by hand, which are accordingly punched out and sewn together. This method is, on the one hand, very costly, and on the other hand the visual appearance of the leather surface can suffer through a flattening of the grain of the leather during this mounting process.

A considerable simplification of the production of such a leather-covered vehicle interior lining results through the use of a back injection method. In this method the material, which is to form the subsequent surface, is placed into an injection mold and is back-molded with the injection molding material. Owing to the relatively great thickness of the leather and the intensive curvatures which have to be realized in components for vehicle interior lining, and also the low capability of leather to expand, the piece of leather must be preformed before being introduced into the injection mold. U.S. Pat. No. 5,650,115 describes a method in which a piece of leather is preformed by a thermal treatment before being inserted into an injection mold. As the deformation of the leather only is effected through heat, the possibility for shaping is restricted. Further, from DE 43 43 240 A1 a method is known in which a leather is back-molded so that a stable intermediate product is made. Subsequently a foil is applied to the molded plastic. Id in a mold, the rear side of the intermediate product is provided with a carrier body. Intermediate product and carrier are, by means of a form-fit, positively connected to each other and, for recycling purposes, may easily be separated from each other during scrapping due to the plastic foil, as they do not enter into a bond.

### BRIEF SUMMARY OF THE INVENTION

The invention provides a leather covering piece for a vehicle interior lining, which piece is able to be processed simply and well able to be put in intermediate storage.

The leather covering piece according to the invention comprises a leather piece and an intermediate layer connected with the leather piece. A hardenable mass is applied onto one of the intermediate layer and the leather piece which after hardening gives the leather covering piece such an inherent rigidity that it maintains a curved shape.

As the inherent stability of the leather covering piece is determined by the hardened mass, also complicated shapes with intensive curves can be realized, so that it is suitable for the production of complicated shapes in a back-injection process. The leather covering piece has such an inherent stability that it maintains its shape despite of its own weight whilst still being flexible. Therefore, the leather covering part can not be installed in the vehicle by itself because of the fact that there is missing the stable carrier part together with which the interior lining is finally defined. It is an advantage that producing—as well as bringing the leather covering into a curved form—can be done prior to making the interior lining, as the leather covering part may readily be put in intermediate storage due to its high inherent stability. The intermediate layer can serve on the one hand as support material for the hardenable mass and on the other hand can form an additional lining, for example for thermal insulation. The intermediate layer can contribute to improving the adhesion between the leather piece and the plastic carrier upon the subsequent manufacture of a vehicle interior lining by back-molding a leather covering piece according to the invention having a plastic carrier piece made of an injection-molding mass.

In DE 43 43 240 A1 there is not present an intermediate layer in the sense of the invention, as here an injection molding material is directly applied onto the leather. However, it is just the intermediate layer why the desired bond to the carrier part is improved; DE 43 43 240 A1 teaches the opposite, i.e. a strict separation of back-molded leather to the carrier part by placing between the plastic foil.

The intermediate layer is preferably a fleece or a fabric which is capable of absorbing a hardenable mass and which is so flexible that it can adapt well to the desired contour.

Preferably an adhesive is used as hardening mass. This has the advantage that the adhesive can also be used for connecting the piece leather with the intermediate layer and in this way only one material has to be used.

In an extension of the invention, the piece of leather is connected with the intermediate layer via a foam layer which serves to improve the feel and also for thermal insulation. This is advantageous particularly in steering wheels.

In a preferred embodiment, the leather covering piece has a front wall and a side wall which runs at an angle to the front wall, and the front and side walls are coated on the inner face at least partially with the hardenable mass. In this way, the side wall can have a free outer edge which is not coated with hardenable mass. During the completion of the vehicle interior lining, this free outer edge can be bent around the outer edges of the plastic carrier piece and can be glued there for example, because it is still flexible.

Such leather covering pieces are able to be used particularly advantageously for vehicle interior linings, in particular for a cover of a gas bag module, a carrier piece being connected with the leather covering piece by back-molding. The leather covering piece according to the invention is suitable for back-molding with a plastic material in an injection mold, because it can be preformed precisely in accordance with this mold and is able to be easily positioned in the mold.

It is, in addition, an object of the invention to present an improved method for the production of a leather covering piece for a vehicle interior lining according to the invention. The method for producing such a leather covering piece comprises the steps of forming a layer series of the leather piece and the intermediate layer, coating the intermediate layer with the hardenable mass, deforming of the leather covering piece into a curved shape with the aid of a mold, hardening the hardenable mass and separating the leather covering piece from the mold.

The hardenable mass applied to the intermediate layer preferably penetrates into the latter, possibly impregnates it and can even connect the intermediate layer with the leather piece. Before the hardening of the hardenable mass, the leather covering piece is then inserted into the mold and brought into the desired shape, and is kept in this mold up to the full or partial hardening of the hardenable mass. After having been taken from the mold, the hardenable mass gives the leather covering piece such an inherent stability that it maintains the curved shape given to it and can be stored until further processing into, for instance, a vehicle interior lining. The connection of the leather piece with the intermediate layer can take place in one working step together with the application of the hardenable mass, whereby the production process is simplified.

An alternative method for the production of a leather covering piece uses the following steps: coating the leather piece with the hardenable mass, applying the intermediate layer onto the leather piece, deforming the leather covering piece into a curved shape with the aid of a mold, in particular a shape corresponding to a vehicle interior lining, hardening the hardenable mass and separating the leather covering piece from said mold.

In this case, the adhesion between the leather piece and the intermediate layer is improved, the intermediate layer here also being able to be impregnated by the hardenable mass.

In addition, before the deformation of the leather covering piece, a hardenable mass can be applied onto the intermediate layer, in order to increase the overall amount of the hardenable mass and to improve the inherent stability and inherent rigidity of the finished leather covering piece. Preferably, the hardenable mass for coating the leather piece and for applying onto the intermediate layer before deformation are of the same material.

In a preferred embodiment, the deformation of the leather covering piece is effected in that the leather covering piece is stretched over a positive mold before the hardening of the mass. The mass is hardened as long as the leather covering piece is situated over the mold.

In an alternative embodiment, the deformation of the leather covering piece is effected in that the leather covering piece is pressed for example by a die into a negative mold before the hardening of the mass. This offers the advantage that through a corresponding shaping of the inner surface of the negative mold, the leather can be given an embossing. Also in this case, the leather covering piece is only removed from the mold after the complete or partial hardening of the mass.

Each hardenable mass used for manufacturing the leather covering piece is different from an injection-molding mass as used for producing the plastic carrier piece. Preferably, the hardenable mass is liquid at room temperature in order to be able of being treated without big expenditure.

Preferably, the hardenable mass is an adhesive. In this way, the use of a single material is sufficient in order to connect the leather piece, the intermediate layer and a possible foam layer and to give the leather covering the necessary inherent rigidity, which simplifies the production of the leather covering piece.

Alternatively, various hardenable mass can also be used in order to bond the intermediate layer with the leather piece and in order to give the leather covering piece the desired inherent rigidity. The hardenable mass used for producing the leather covering piece differs from an injection molding mass used for producing a carrier piece of plastics. Preferably, the hardenable mass is liquid at room temperatures so that it can be applied onto the leather or the intermediate layer in a simple manner.

A leather covering piece described above can be used for the production of a vehicle interior lining according to the invention, in particular a covering of a gas bag module. The following steps are provided:

a) producing a leather covering piece as defined above,

b) inserting said leather covering piece into an injection mold,

c) back-molding of an inner face of said leather covering piece with a plastic to form a carrier piece, and

d) removal of said vehicle interior lining from said injection mold.

Owing to the variable deformability and also the high inherent rigidity, the leather covering piece can also be adapted well to intensely curved and complicated injection molds and can be back-molded with low expenditure. The leather covering piece forms, as it were, the “leather case” of the parts of the vehicle interior lining which are visible from the vehicle interior. The curved shape of the leather covering piece corresponds to the curved shape of the mold in which it is arranged. Therefore, the leather covering piece has the curved shape of the vehicle interior lining.

### BRIEF DESCRIPTION OF THE DRAWINGS

FIG. 1 shows a partial view of a leather covering piece according to the invention, in section;

FIG. 2 shows an enlarged section through the leather covering piece according to FIG. 1;

FIG. 3 shows an enlarged section through a leather covering piece according to the invention, according to a second embodiment;

FIG. 4 shows an enlarged section through a leather covering piece according to the invention, according to a further embodiment;

FIG. 5 shows a partial view of a vehicle interior lining according to the invention, in section;

FIG. 6 shows a section through a leather covering piece mounted on a positive mold;

FIG. 7 shows a section through a leather covering piece pressed into a negative mold; and

FIG. 8 shows a schematic section view of an injection mold with a vehicle interior lining.

### DETAILED DESCRIPTION OF THE PREFERRED EMBODIMENTS

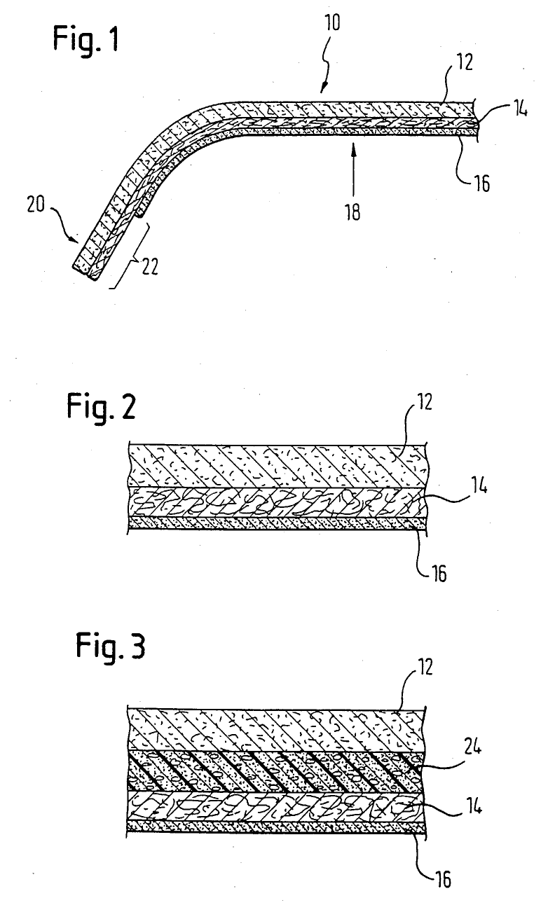

FIG. 1 shows a finished leather covering piece 10 according to the invention, as can be used for a vehicle interior lining, for example a cover cap of a driver's gas bag module. The leather covering piece 10 has a leather piece 12 forming the outer surface of the lining, which leather piece 12 is connected with an intermediate layer 14 lying therebeneath. A hardenable mass 16 is applied onto the intermediate layer 14, which is hardened in the finished leather covering piece 10 shown in FIG. 1 and which keeps the leather covering piece 10 in a curved shape.

The leather covering piece 10 illustrated has a front wall 18 and a side wall 20, the side wall running at an angle with respect to the front wall. The side wall 20 is only partially coated with the hardenable mass 16, so that a free outer edge 22 is produced. This outer edge can either, as illustrated in FIG. 1, consist of the leather piece 12 and the intermediate layer 14 or only of the leather piece 12. During completion of the vehicle interior lining 26, this free outer edge 22 which has the original flexibility of the leather, is bent around a carrier piece 28 and will be fixed to it, as described below.

The production of the leather, covering piece 10 is described below. In a first method, the leather piece 12 and the intermediate layer 14 are brought one on another and are coated with a hardenable mass 16 (see the embodiment illustrated in FIG. 2). In the process, the hardenable mass 16 penetrates the intermediate layer 14, impregnates it and connects the leather piece 12 with the intermediate layer 14. Preferably as hardenable mass 16 an adhesive is used which both can bond the leather piece 12 to the intermediate layer 14 and also shows a sufficiently high inherent rigidity after hardening, so that the leather covering piece 10 maintains its curved shape. Preferably, the hardenable mass is liquid at room temperature and differs from the injection-molding mass from which the carrier piece 28 is preferably formed.

As intermediate layer 14 preferably a fabric or a fleece with a relatively great thickness is used, which is soft enough to adapt itself to the desired shape and which can be impregnated with the hardenable mass 16 which is used.

Then the layer series of leather piece 12 and intermediate piece 14 with the applied hardenable mass 16 is either stretched over a positive mold 23, the shape of which corresponds to the desired vehicle interior lining, or is pressed into a corresponding negative mold 25. The pressing can take place with a die 27. Both the die 27 and also the negative mold 25 can have embossings, in order to give the surface of the leather piece 12 or the inner face of the leather covering piece 10 a desired embossing, for example in the form of a grain to improve the visual appearance of the leather surface.

The leather covering piece 10 is left in the mold until the hardenable mass 16 has fully or partially hardened.

After removal from the mold, the leather covering piece 10 can then be stored until its further processing.

In an alternative method, the leather piece 12 is firstly connected with a foam layer 24 (see the embodiment shown in FIG. 3), which for example serves to improve the feel of the vehicle interior lining. The connection of the leather piece 12 with the foam layer 24 can take place either with the same hardenable mass 16 which is used for the shaping of the leather covering piece 10, or with a different suitable adhesive. The foam layer 24 is connected with the intermediate layer 14, which in turn is coated with a hardenable mass 16. The remaining method proceeds as described above.

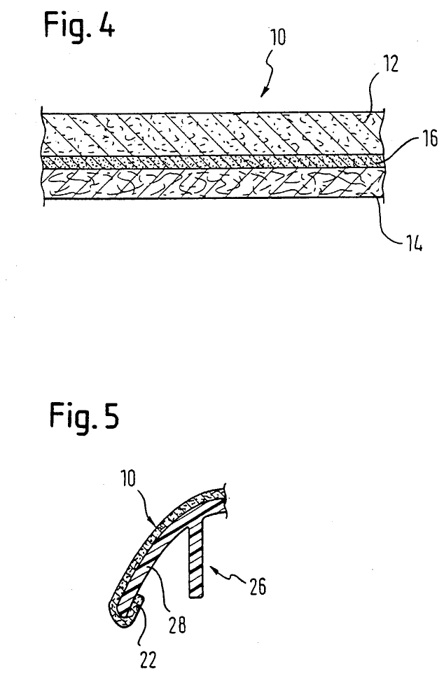

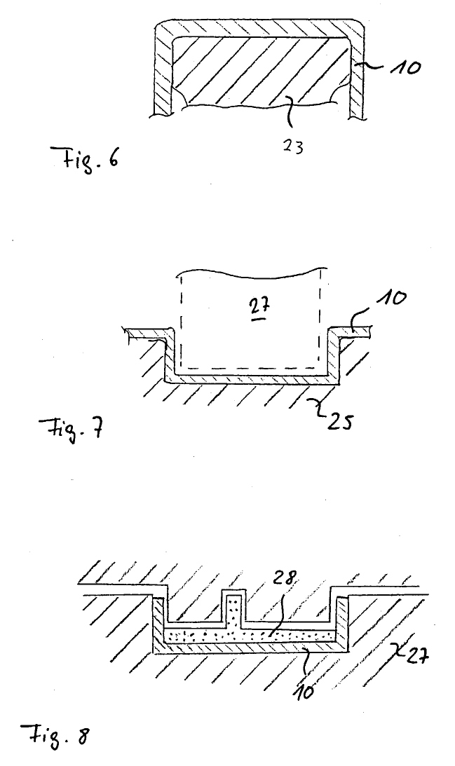

A further method makes provision that the hardenable mass 16 is applied directly onto the leather piece 12 and subsequently the intermediate layer 14 is applied onto the hardenable mass 16, as the embodiment illustrated in FIG. 4 shows. Also in this case the hardenable mass 16 impregnates the intermediate layer 14.

In this case the hardenable mass 16 also serves for connection between the leather piece 12 and the intermediate layer 14. In addition, a further layer of the same or of a different hardenable mass 16 can be applied onto the intermediate layer 14. The deformation of the leather covering piece 10 is effected as described above.

For the production of a vehicle interior lining 26, the leather covering piece 10 formed after the hardening of the material 16 is now placed into an injection mold 27 in which it can be fixed in position in a known manner by a vacuum, and in a known method is back-molded with an injection-molding mass to form a plastic carrier piece 28, so that a vehicle interior lining 26 is formed from the leather covering piece 10 and the carrier piece 28. After the removal of the back-molded leather covering piece 10, the free outer edge 22 can be bent around the free edge of the plastic carrier piece 28 by hand and can be bonded to the inner face of this edge.

A 90° deflection of the free outer edge can be realized in an injection molding tool, a 180° deflection, as shown in FIG. 5, must be made subsequently by hand, however.

The use of a fleece as intermediate layer 14 also provides for a good connection of the carrier piece 28 with the leather covering piece 10 during back-molding.

1. A leather covering piece for a vehicle interior lining, said piece comprising
a leather piece and
an intermediate layer connected with said leather piece,
a hardenable mass being applied onto one of said intermediate layer and said leather piece which after hardening gives said leather covering piece such an inherent rigidity that it maintains a curved shape.

2. The leather covering piece according to claim 1, wherein said intermediate layer is a fleece.

3. The leather covering piece according to claim 1, wherein said intermediate layer is a fabric.

4. The leather covering piece according to claim 1, wherein said hardenable mass is an adhesive.

5. The leather covering piece according to claim 4, wherein said adhesive is also provided for connecting said leather piece with said intermediate layer.

6. The leather covering piece according to claim 1, wherein said leather piece is connected with said intermediate layer via a foam layer.

7. The leather covering piece according to claim 1, wherein it has a front wall and a side wall running angled to said front wall, and wherein said front and side walls are coated on an inner face at least partially with said hardenable mass.

8. The leather covering piece according to claim 7, wherein said side wall has a free outer edge which is not coated with said hardenable mass.

9. A vehicle interior lining, in particular a cover for a gas bag module, said lining comprising a leather covering piece with
a leather piece and
an intermediate layer connected with said leather piece,
a hardenable mass being applied onto one of said intermediate layer and said leather piece which after hardening gives said leather covering piece such an inherent rigidity that it maintains a curved shape,
said lining further comprising a carrier piece connected with said leather covering piece,
said leather covering piece being back-molded and the back-molded piece forming the carrier piece.

10. The vehicle interior lining according to claim 9, wherein said hardenable mass is an adhesive.

11. A method for the production of a leather covering piece with a leather piece and an intermediate layer connected with said leather piece, a hardenable mass being applied onto one of said intermediate layer and said leather piece which after hardening gives said leather covering piece such an inherent rigidity that it maintains a curved shape,
said method comprising the following steps:
forming a layer series of said leather piece and said intermediate layer,
coating said intermediate layer with said hardenable mass,
deforming of said leather covering piece into a curved shape with the aid of a mold,
hardening said hardenable mass and
separating said leather covering piece from said mold.

12. The method according to claim 11, wherein an adhesive is used as said hardenable mass.

13. The method according to claim 11, wherein said deformation of said leather covering piece is effected in that said leather covering piece is stretched over a positive mold before hardening of said hardenable mass.

14. The method according to any of claims 11, wherein said deformation of said leather covering piece is effected in that said leather covering piece is pressed into a negative mold before hardening of said mass.

15. A method for the production of a leather covering piece with a leather piece and an intermediate layer connected with said leather piece, a hardenable mass being applied onto one of said intermediate layer and said leather piece which after hardening gives said leather covering piece such an inherent rigidity that it maintains a curved shape,
said method comprising the following steps:
coating said leather piece with said hardenable mass, applying said intermediate layer onto said leather piece,
deforming said leather covering piece into a curved shape with the aid of a mold,
hardening said hardenable mass and
separating said leather covering piece from said mold.

16. The method according to claim 15, wherein an adhesive is used as said hardenable mass.

17. The method according to claim 15, wherein before the deformation of said leather covering piece a hardenable mass is applied onto said intermediate layer.

18. The method according to claim 15, wherein said deformation of said leather covering piece is effected in that said leather covering piece is stretched over a positive mold before hardening of said hardenable mass.

19. The method according to claim 15, wherein said deformation of said leather covering piece is effected in that said leather covering piece is pressed into a negative mold before hardening of said mass.

20. A method for the production of a vehicle interior lining comprising the steps of
a) producing a leather covering piece by
forming a layer series of a leather piece and an intermediate layer,
coating said intermediate layer with a hardenable mass,
deforming said leather covering piece into a curved shape with the aid of a mold,
hardening said hardenable mass and
separating said leather covering piece from said mold,
b) inserting said leather covering piece into an injection mold,
c) back-molding of an inner face of said leather covering piece with a plastic to form a carrier piece, and
d) removal of said vehicle interior lining from said injection mold.

21. A method for the production of a vehicle interior lining comprising the steps of
a) producing a leather covering piece by
coating said leather piece with said hardenable mass,
applying said intermediate layer onto said leather piece,
deforming said leather covering piece into a curved shape with the aid of a mold,
hardening said hardenable mass and
separating said leather covering piece from said mold,
b) inserting said leather covering piece into an injection mold,
c) back-molding of an inner face of said leather covering piece with a plastic to form a carrier piece, and
d) removal of said vehicle interior lining from said injection mold.
